(19) United States
(12) Patent Application Publication
(10) Pub. No.: US 2019/0011575 A1
(43) Pub. Date: Jan. 10, 2019

(54) Plastic Scintillator Radiation Detector Having Improved Optical Clarity and Radiation Sensitivity and Method of Manufacture

(71) Applicant: Ludlum Measurements, Inc., Sweetwater, TX (US)

(72) Inventors: Richard Smola, Sweetwater, TX (US); William Miller, Sweetwater, TX (US)

(21) Appl. No.: 15/642,759

(22) Filed: Jul. 6, 2017

(51) Int. Cl. G01T 1/203; G01T 1/20; G01T 7/00

(52) U.S. Cl. CPC G01T 1/203; G01T 7/00; G01T 1/2018

(57) ABSTRACT

A plastic scintillator radiation detector with improved optical clarity, radiation sensitivity and lifetime. A method for making such a radiation detector includes providing a dry plastic scintillator and sealing the processed plastic scintillator in an enclosure to isolate the radiation detector from humidity.

### BACKGROUND

### Technical Field of the Invention

The present invention relates to radiation detectors made of plastic scintillators, and more particularly to a plastic scintillator radiation detector having improved optical clarity, radiation sensitivity and lifetime, and a method for making the improved plastic scintillator radiation detector.

### Related Art

Scintillators are materials that luminesce when excited by ionizing radiation. When a scintillator is struck by an incoming particle, it will absorb its energy and scintillate, i.e., re-emit the absorbed energy in the form of light. The re-emitted light can be detected by light-sensing devices, such as a photomultiplier tube, which generate electronic current corresponding to the intensity of the received light and subsequently the intensity of the radiation. Certain scintillators when combined with photomultiplier tubes or other light sensors are used as gamma radiation detectors.

A number of different types of materials have historically been used as scintillators. These include, organic crystal scintillators, plastic scintillators, glass scintillators, and inorganic crystal scintillators. Inorganic crystal scintillators have scintillation properties by virtue of their crystalline structure. This structure creates the energy bands between which electrons can jmp up to higher energy levels by excitation through ionizing radiation or down to lower energy levels by de-excitation through emission of visible photons. They offer excellent light output and energy resolution, a fast response, excellent linearity, and stable light output over a wide range of temperatures. However, they are generally extremely hydroscopic and must be isolated from moisture. In some cases this has been accomplished by applying a plastic film around the inorganic crystalline scintillator. Materials used for this purpose have included, glass and metal as well as plastics such as polyethylene terephthalate, polyolefin-, polyacetal-, epoxy-, polyimide-, silicone-, or poly(para-xylyene)-based material.

On the other hand, plastic scintillators are composed of aromatic hydrocarbons that scintillate on a molecular level and no crystal structure is needed. The advantages of plastic scintillators include fairly high light output, a relatively quick signal, and their ability to be shaped, through the use of molds or other means, into almost any desired form with what is often a high degree of durability. Another advantage is that they are not viewed as being hydroscopic like inorganic crystalline scintillators and thus additional precautions against moisture have conventionally not been required or used.

Plastic scintillators have been widely used as the gamma detectors of choice since being identified and developed in the 1970's and 1980's, largely by Paul Fehlau of Los Alamos National Lab. They are most notably used in walk-through and drive-through systems made for nuclear security of SNM (Special Nuclear Material). In 1987, Paul Fehlau of Los Alamos National Laboratory wrote “An Applications Guide to Vehicle SNM Monitors” that covered their theory, use, and commercially available systems. Large deployments of such detectors include the US governments Second Line of Defense (SLD) program, started in 1998 and, since 2001, the Radiation Portal Monitor (RPM) project.

One of the problems with plastic scintillator detectors is their relatively short life-time, which is approximately 10 years or so. Oxidation (i.e., yellowing) and crazing of the plastic are two common problems that interfere with optical clarity and light transmission of these normally optically clear plastics, thus reducing the life-time. There has been some research into these problems. For example, Zhou, Tianfu et al studied the long-term stability of plastic scintillator in “The long-term stability of plastic scintillator for electromagnetic particle detectors”, Vol. 4, pp. 346-349, 32nd International Cosmic Ray Conference, Beijing 2011. V. Sinchishin, et al, in “New radiation stable and long-lived plastic scintillator for the SSC”, also discussed the aging problem and pointed out that the uncured monomer in the plastic scintillator is a primary cause. However, no satisfactory answers have been found regarding the root of cause of the problems and corresponding solutions to the problems.

Since the start of the RPM project in the U.S., a large number of radiation detection devices or systems have been installed on the U.S. border and ports. These systems, operated 24/7 in all sorts of environmental conditions, are monitored closely. Two characteristics have been observed. One is the temporary drop in gamma sensitivity at cold temperatures (i.e., below −20° C.). The other is the permanent drop in gamma sensitivity because some plastic scintillators became “cloudy” after only approximately 5-6 years resulting in a lifetime issue. These plastic scintillator detectors are replaced, at some cost, whenever their sensitivity permanently drops.

The Department of Homeland Security (DHS) has taken note of these problems, and has developed programs for researching on these issues. One of the major goals of the programs, started in 2010, is to extend the lifetime of the plastic scintillator detectors used in the installed base of 1400 systems (possibly 5600 plastic scintillator detectors). Unfortunately, no root causes or solutions have been found so far.

Therefore, there continues to be a need for a plastic scintillator radiation detector with improved optical clarity and radiation sensitivity, thus prolonging lifetime of the plastic scintillators and the radiation detectors.

### BRIEF SUMMARY OF THE INVENTION

A plastic scintillator radiation detector with improved optical clarity and radiation sensitivity and a method of manufacture are disclosed. The present disclosure discloses a method for making a radiation detector using a plastic scintillator that involves starting with a dry plastic scintillator and sealing it in a moisture resistant enclosure that is preferably also airtight. Preferably the plastic scintillator is maintained in a dry or low humidity environment prior to being sealed in the enclosure. Preferably, the enclosure is an air-tight enclosure composed of metal such as aluminum that can maintain a vacuum or a dry inert atmosphere such as nitrogen within the enclosure so as to prevent moisture from contacting the plastic scintillator.

### DETAILED DESCRIPTION OF THE INVENTION

The following discussion is presented to enable a person skilled in the art to make and use of the invention. Various modifications will be readily apparent to those skilled in the art, and the general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

It has been discovered that one of the causes of the causes of the shortened lifetime of current plastic scintillators is permanent cloudiness that forms in the plastic scintillator. This cloudiness is caused by the combination of low temperatures and moisture absorption of the plastic scintillator. In particular, moisture accumulated heavily on the surface of the plastic scintillators of the detectors at low temperatures, causing cloudiness of the surface and permanent damage to the detectors. This cloudiness and damage is directly responsible for the problems discussed above regarding the lifetime and radiation sensitivity of the plastic scintillation detectors. As a result of this discovery, methods and apparatuses are disclosed for improving the optical clarity, radiation sensitivity and lifetime of plastic scintillators.

To support this discovery, an experiment was conducted to show the relationship between the cloudiness of a plastic scintillator and the moisture absorption of the plastic scintillator. Two sets of four EJ-200 plastic scintillators were provided. The four scintillators in each set had a thickness of 1 inch, 1½ inches, 2 inches, and 2½ inches respectively. The plastic scintillators in both sets were exposed to atmospheric humidity for over a year, thereby absorbing some undetermined amount of moisture from the air. The first set was placed into a humid environmental chamber for 30 days with humidity of 80% or greater. The second set was placed into a sealed chamber with silica gel desiccant for 30 days. At the end of the 30 days, all eight plastic scintillators were taken out of the chambers and placed into a cold temperature environmental chamber at a temperature of −30° C. for several hours. The eight plastic scintillators were then taken out from the cold chamber. It was observed that, while the scintillators are still cold, that the first set of plastic scintillators that had been placed into a humid chamber has developed cloudiness on the scintillator surface and the second set that has been placed into sealed chamber with silica gel desiccant remained clear. This experiment shows clearly that cloudiness that develops in the plastic scintillators at low temperature can be caused by the moisture absorbed by the plastic scintillators.

In order to prevent or reduce moisture and humidity absorption of a plastic scintillator, one aspect of the invention is to isolate the plastic scintillator from humidity in the process that plastic scintillators are made prior to the plastic scintillator being made as a radiation detector. Another aspect of the invention is to seal a radiation detector that has been built from humidity during the service life of the detector. These aspects can be practiced individually or preferably in combination with each other, specifically to isolate the plastic scintillator from humidity before the plastic scintillator is made into a radiation detector and seal the radiation detector that has been made from humidity during the life of its service.

During the process of making a plastic scintillator, a plastic scintillator slab is cured in an oven for several days. When removed from the oven, the plastic scintillator slab is considered “dry.” The moisture content of the dry plastic scintillator is estimated to be less than 200 ppm. However, without adequate precautions, the plastic material will soon absorb moisture from the surrounding air and thus exhibits the problems discussed above, such as the surfaces of the plastic scintillators become “cloudy,” plastic scintillators become oxidized, and radiation sensitivity the plastic scintillators drops. To keep the plastic scintillator slab dry, a plastic scintillator, prior to being made into a radiation detector, may be kept isolated from humid environment. The plastic scintillator can be stored in an individually sealed metal enclosure, that optionally may contain a desiccant. Alternatively, the plastic scintillator can be stored in a specially constructed “dry” room which is kept dry using a regenerative air dryer or other similar drying methods. The room or container in which the plastic scintillator is stored should be sufficiently dry that it has a dew point of 0 degrees C. or better.

Before a plastic scintillator is used as a radiation detector, it has to be processed. The plastic scintillator is machined to an appropriate size and/or shape, for example, a rectangular block shape. Care is taken to make a smooth surface of the plastic scintillator for maximum internal reflection. The plastic scintillator is then surrounded by a reflector layer, such as aluminum foil or other reflective surface to further improve internal reflection. The plastic scintillator, together with the surrounded reflector layer is then sealed from ambient light using a low-density opaque material. The low-density opaque materials used are typically plastic, such as vinyl, and thus form no barrier to humidity. A singular or multiple light-sensitive devices, such as a Photomultiplier Tube (PMT), are attached to the plastic scintillator over an opening in the opaque material and reflective layer in order to collect the radiation-produced scintillations of light. The light-sensitive devices function to convert the light into electrical pulses or current, which can then be easily measured. The plastic scintillator, the reflector layer, the opaque sealing, and the PMT form the radiation detector. The radiation detector is then mounted in a protective enclosure, such as a housing providing physical protection, and placed as needed with other detectors to form a vehicle, pedestrian, or package “portal”, detecting small amounts of radiation that pass through this portal.

Conventional protective enclosures for the overall radiation detector as described above generally does not seal the radiation detector from humidity. At most they are designed to protect the radiation detector from wet precipitation but not from humidity or moisture that is present in the air. Even then the failure of an entry gasket to close or to be compressed adequately when closed as well as cable penetrations would allow water or humid air to enter the detector's enclosure. Further, the detector's enclosure will periodically need to be opened for servicing, and the opening exposes the interior of the enclosure and thus the plastic scintillator to humid air. Even if a detector's enclosure happened to be able to sufficiently prevent moisture from the air, the plastic scintillator would still have clouding problems and a shortened lifespan due to the moisture and/or humidity present in the plastic scintillator and/or the enclosure before it was closed off. This is because no efforts have been conventionally carried out to prevent the scintillator from absorbing moisture during the period of time after it was cured and before the radiation detector is assembled and placed in the conventional protective enclosure.

To isolate the plastic scintillator from humidity, it is preferred to use an enclosure to seal the plastic scintillator to provide a moisture proof barrier. It is preferred that the plastic scintillator has remained in a dry or extremely low moisture environment from the time it was cured in an oven until it is installed in the moisture proof enclosure. Further, it is also preferable that the installation process itself occur in a room that has as low a moisture or humidity content as practical in order to further avoid moisture absorption by the plastic scintillator during the assembly process.

The enclosure should preferably be composed of an appropriate material and be sufficiently thick to provide both the required an opaque enclosure for the plastic scintillator as well as prevent or at least sufficient resist moisture from passing through to the plastic scintillator. For purposes of this invention, minimizing the moisture from the ambient atmosphere from contacting the plastic scintillator means that the enclosure has a moisture permeability of less than 1×10⁻⁶ g/m² per day. A preferred material for the enclosure is aluminum. Moisture is preferably completely prevented from passing through the enclosure by forming an air-tight enclosure that allows a reduced pressure or vacuum to be created inside the enclosure and remain over the intended life of the plastic scintillator. If a reduced pressure vacuum is created inside the enclosure it should preferably be from about 14.5 to about 14.7 psia. Alternatively, the enclosure could be configured to be sufficiently air-tight to contain a dry inert atmosphere within the enclosures, such as dry nitrogen gas. Any such inert gas should have a moisture content of less than 5 ppm. In addition, the enclosure should preferably also have a composition and thickness sufficient to prevent puncturing during the expected routine handling and maintenance of the plastic scintillator in the radiation detector over the course of its intended lifetime.

It is currently believed that to prevent fogging the moisture content of the plastic scintillator should be kept below about 200 ppm. Preferably this is accomplished by maintaining the scintillator in a low moisture environment from the time it is cured until the time it is sealed in an enclosure that is resistant to moisture penetration. It is also preferred that the enclosure be air-tight, have a moisture permeability of less than about 1×10⁻⁶ g/m² per day, and have a reduced pressure vacuum inside the enclosure of from about 14.5 to about 14.7 psia or an inert atmosphere with a moisture content of less than 5 ppm. Further, it is preferred that a desiccant is included in the enclosure to at least partially absorb any moisture that may be present. However, one of skill in the art will recognize that various combinations of these preferred aspects can be used and that other parameter values can be used as long as the moisture content of the plastic scintillator is maintained at a moisture content that is less than about 200 ppm. For example, additional desiccant can be used to offset an enclosure that has a somewhat higher moisture permeability or the fact that the plastic scintillator was in contact with an environment that had a somewhat higher moisture content before it was sealed in the enclosure.

While the invention is discussed below in connection with various preferred embodiments it should be understood that various features or aspects of each embodiment can preferably be combined with or substituted for features or aspects of any of the other embodiments.

In a first preferred embodiment, an aluminum pan having a thickness of 0.090 inches and having a bottom, two sides and two ends is provided that is sized to accept the plastic scintillator. Preferably, the top of the sides and ends further extend outward to form a flat lip for securing the top of the enclosure. In one end of the pan, a vacuum port is provided. One or more openings for a photomultiplier tube is also provided in one of the ends, preferably the end opposite from the vacuum port. The seams of the pan are all welded in order to provide air tight seals. A glass cover, preferably borosilicate glass, is attached over the opening(s) for the photomultiplier tube and secured in place with an air tight (and thus moisture proof) seal, such as by using epoxy.

A layer of desiccant paper or other desiccant material is placed in the bottom of the tray. The desiccant paper preferably contains about 0.58 pounds of silica gel with an approximate absorption water capacity of about 0.15 pounds. The purpose of the desiccant paper is to absorb moisture that may be present in the air of the enclosure or any of the components in the enclosure as well as moisture that might intrude into the enclosure, whether due to failure of a seal or that may accumulate due to the permeability of the materials used to form the enclosure. The plastic scintillator, which has been conventionally wrapped in a reflective layer of aluminum foil with one or more holes cut in an end for the photomultiplier tube is then placed into the pan. Other reflective layers or light sensors may, of course, also be used.

If desired, a pusher plate can be placed at one end of the plastic scintillator. The pusher plate, in connection with two or more pusher screws that thread through the end of the aluminum pan can be used to push the plastic scintillator toward the end of the pan where the photomultiplier window(s) are located. This helps ensure good optical contact between the plastic scintillator and the photomultiplier tube. As an alternative, a compressed pad such as a sponge can be placed against one end of the pan so that as the pad tries to expand back to its original thickness it similarly urges the plastic scintillator toward the end with the photomultiplier tube. Of course, any such pusher plate or compressed pad should not obstruct the vacuum port if it is located in the same end. Further, once the scintillator is installed and the pressure plate adjusted, the threads of the pusher screws should be coated with an adhesive such as epoxy or other sealant so as to ensure that the enclosure remains air-tight and thus moisture proof.

An aluminum top is then secured onto the top of the pan. This can be accomplished by using an adhesive such as epoxy to provide an air-tight seal between the top and the lips of the sides and ends of the aluminum pan. The top is preferably about 0.063 inches thick and may contain a number of thinner window portions that are only about 0.010 inches thick to facilitate the entry of the gamma rays into the enclosure. It is known that aluminum sheet of 0.001 or less may contain pin-holes, which would not be preferred. A thickness of 0.010 inches avoids the pinhole problem, and yet does not interfere with low energy gamma rays. Once the top is secured in place and the epoxy sealant has cured, a vacuum is attached to the vacuum port. A vacuum of about 0.2 psi is pulled on the container to remove any air and accompanying moisture that may be present in the enclosure. After a vacuum is created in the enclosure, a plug is added to the vacuum port and sealed in place such as with epoxy so as to ensure that the enclosure remains under a vacuum or reduced pressure. As an alternative to pulling a vacuum, a dry inert gas such as nitrogen can be used to purge any air (and accompanying moisture) out of the enclosure. At this point, the photomultiplier tubes can be attached over the glass windows in one end and the completed scintillator unit is ready to be installed in the larger radiation detector device.

In an alternative embodiment, an aluminum sheet that is preferably about 0.090 inches thick is bent to form a support comprising a bottom and two long sides that match the dimensions of the plastic scintillator. Two aluminum end caps are also formed of aluminum sheets that is also preferably about 0.090 inches thick. Each end cap has lips formed on the top, bottom and two sides that overlap the sides and bottom of the aluminum support. All the seams are welded in order to provide an air-tight seal. One end has a tubular aluminum enclosure for the photomultiplier tube secured over an opening in the end. Glass, preferably borosilicate glass, is secured over the opening in the end, preferably using epoxy. The other end preferably has a vacuum port opening in it.

The plastic scintillator, which may already have been wrapped in aluminum foil to provide a reflective layer, is placed in the aluminum support, preferably over a sheet of desiccant paper as discussed above with respect to the first embodiment. Then the end caps are slid over the ends of the combined scintillator/support. A compressible pad is preferably used on the end of the scintillator opposite from where the photomultiplier tube is located so as to urge the scintillator into closer contact with the photomultiplier tube. However, alternate structure such as the pusher plate and pusher screws discussed above can alternatively be used. The end caps are secured to the aluminum support using an adhesive such as epoxy so as to provide an air-tight and thus moisture tight seal.

An aluminum foil skin, with a thickness of 0.001 to 0.010 inches is then wrapped around the enclosure with the sides overlapping and adhered using epoxy to the lips on each end. The aluminum foil skin can also be secured to the sides and bottom of the aluminum support. Preferably, the aluminum foil skin overlaps itself on the bottom of the aluminum support. All the seams in the aluminum foil are adhered either to the caps, support or back on the foil itself using an adhesive such as epoxy to provide an air-tight seal. Once the adhesive is cured, a vacuum can be used to apply a slight vacuum to the container. Alternatively, as discussed above the vacuum port can instead be used to purge air out of the enclosure and replace it with a dry inert gas such as nitrogen.

In a third embodiment, the plastic scintillator is once again wrapped in aluminum foil to provide a reflective layer, except for the end location where the photomultiplier tube will be located. Then the top, bottom sides and ends are covered with vinyl sheets that are cut to the size of the plastic scintillator. The vinyl sheets are taped together at their edges using vinyl/electrical tape to provide an opaque covering for the scintillator. The vinyl sheet at one end of the plastic scintillator is either sized or contains an opening in it where the photomultiplier tube will be located.

Two aluminum end caps are provided that are approximately 0.25 inches thick. One end cap has a tubular aluminum cylinder adapted to hold the photomultiplier tube over a hole in the end cap. Preferably the hole for the photomultiplier tube is sealed with glass, preferably borosilicate glass as discussed above with respect to the other embodiments. The other end cap preferably has a vacuum port. The end caps are preferably sufficiently thick at the edges so as to provide a lip for adhering an aluminum foil skin to the edges. As before, any seams are welded or otherwise sealed to provide an air-tight and moisture tight seal. Four support rods, preferably composed of aluminum are posited along the long edges of the plastic scintillator and secured to the corners of the end caps by screws through the end caps into the end of the support rods. As discussed above, a compressible pad or pusher plate can be added between on end plate and the plastic scintillator in order to urge the plastic scintillator into a sufficiently close contact with the other end cap that includes the window for the photomultiplier tube. After the plastic scintillator is secured between the end caps and between the support bars, an aluminum foil skin having a thickness of 0.001 to 0.010 inches is wrapped around the unit. Optionally, as discussed above, a sheet of desiccant paper can be included on or under the plastic scintillator prior to its being wrapped in the aluminum foil skin. An adhesive, such as epoxy is used to adhere the foil skin to the edges of the end caps. The foil skin is also long enough to wrap around the entire plastic scintillator unit and overlap the starting end so that it can be secured back on itself using an adhesive such as epoxy. Additional foil, epoxy or other sealing composition also is applied either over the screw heads, to the threads, or to the underside of the heads so as to provide an air-tight and thus moisture tight seal for the enclosure. Like the other embodiments, once all the adhesive has dried a vacuum is pulled from the vacuum port in order to ensure that the enclosure is air-tight and thus resistant to moisture entry.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the spirit and scope of the disclosed embodiments as defined in the appended claims.

1. An improved radiation detector comprising:
a plastic scintillator capable of releasing electromagnetic radiation in response to contact with ionizing radiation;
a detector optically secured to the plastic scintillator so it is capable of detecting the released electromagnetic radiation and converting it to an electrical signal;
an air-tight enclosure surrounding the plastic scintillator, wherein the air-tight enclosure minimizes moisture from an ambient atmosphere from contacting the plastic scintillator;
wherein the plastic scintillator has a moisture content less than about 200 ppm;

2. The radiation detector of claim 1 wherein the enclosure has a reduced internal pressure compared to the ambient atmosphere.

3. The radiation detector of claim 1 wherein the enclosure contains an inert atmosphere.

4. The radiation detector of claim 3 wherein the inert atmosphere is nitrogen.

5. The radiation detector of claim 1 wherein the air-tight enclosure is composed of a material having a moisture permeability of less than about 1×10⁻⁶ g/m² per day.

6. The radiation detector of claim 1 wherein the enclosure is composed of a metal.

7. The radiation detector of claim 1 wherein the enclosure further contains a desiccant.

8. The radiation detector of claim 1 wherein the electromagnetic radiation is photons of visible light and the detector is a photomultiplier tube.

9. The radiation detector of claim 8 wherein the enclosure has a reduced internal pressure compared to the ambient atmosphere.

10. The radiation detector of claim 8 wherein the enclosure contains an inert atmosphere.

11. The radiation detector of claim 10 wherein the inert atmosphere is nitrogen.

12. The radiation detector of claim 8 wherein the enclosure is composed of a metal.

13. The radiation detector of claim 8 wherein the enclosure further contains a desiccant.

14. The radiation detector of claim 13 wherein the enclosure is composed of aluminum.

15. The radiation detector of claim 1 wherein the enclosure further minimizes visible light from contacting the plastic scintillator.

16. A method for making a radiation detector comprising:
processing a cured polymeric composition to form a plastic scintillator capable of releasing electromagnetic radiation in response to contact with ionizing radiation;
wherein the cured plastic scintillator has a moisture content less than about 200 ppm;
maintaining the plastic scintillator following curing in a low moisture environment having a moisture content with a dew point of less than about 0 degrees C.;
processing the scintillator to improve internal reflections;
sealing the plastic scintillator in an air-tight enclosure to minimize moisture from an ambient atmosphere from contacting the plastic scintillator; and
optically securing a detector to the plastic scintillator so it is capable of detecting the released electromagnetic radiation and converting it to an electrical signal.

17. The method of claim 16 wherein the step of processing the scintillator to improve internal reflections comprises surrounding the plastic scintillator with a reflective layer.

18. The method of claim 16 wherein the step of maintaining the plastic scintillator in a low moisture environment comprises storing the plastic scintillator in an air-tight enclosure that contains a desiccant.

19. The method of claim 16 wherein the step of maintaining the plastic scintillator in a low moisture environment comprises storing the plastic scintillator in an enclosure that comprises regenerative air dryers.

20. The method of claim 16 further comprising the step of reducing an internal pressure of the enclosure compared to the ambient atmosphere.

21. The method of claim 16 further comprising filling the enclosure with an inert atmosphere.

22. The method of claim 21 wherein the inert atmosphere is nitrogen.

23. The method of claim 16 wherein the air-tight enclosure is composed of a material having a moisture permeability of less than about 1×10⁻⁶ g/m² per day.

24. The method of claim 16 wherein the enclosure is composed of a metal.

25. The method of claim 16 further comprising adding a desiccant within the enclosure.

26. The method of claim 16 where the electromagnetic radiation is photons of visible light and the detector is a photomultiplier tube.

27. The method of claim 26 wherein the step of processing the scintillator to improve internal reflections comprises surrounding the plastic scintillator with a reflective layer.

28. The method of claim 26 wherein the step of maintaining the plastic scintillator in a low moisture environment comprises storing the plastic scintillator in an air-tight enclosure that contains a desiccant.

29. The method of claim 26 wherein the step of maintaining the plastic scintillator in a low moisture environment comprises storing the plastic scintillator in an enclosure that comprises regenerative air dryers.

30. The method of claim 26 further comprising the step of reducing an internal pressure of the enclosure compared to the ambient atmosphere.

31. The method of claim 26 further comprising filling the enclosure with an inert atmosphere.

32. The method of claim 31 wherein the inert atmosphere is nitrogen.

33. The method of claim 26 wherein the enclosure is composed of a metal.

34. The method of claim 26 further comprising adding a desiccant within the enclosure.

35. The radiation detector of claim 16 wherein the enclosure further minimizes visible light from contacting the plastic scintillator.
